(19) United States
(12) Patent Application Publication
(10) Pub. No.: US 2005/0091470 A1
(43) Pub. Date: Apr. 28, 2005

(54) Calculation of gray codes using exhaustive combinations

(76) Inventor: Anand Pande, Bangalore (IN)

Correspondence Address: CHRISTOPHER C. WINSLADE;MCANDREWS, HELD & MALLOY, LTD, 500 WEST MADISON ST., 34TH FLOOR, CHICAGO, IL, 60661, US

(21) Appl. No.: 10/715,064

(22) Filed: Nov. 17, 2003

Related U.S. Application Data
(63) Continuation-in-part of application No. 10/692,957, filed on Oct. 24, 2003.

(51) Int. Cl. G06F 12/00

(52) U.S. Cl. 711/217

(57) ABSTRACT

A system and method for generating a sequence of 2D addresses, the sequence having the property of a Hamming distance of one between consecutive addresses and the circular property, where D is an arbitrary integer. A sequence of length equal to the next power of 2, from 2D, is used to determine the sequence of 2D addresses. The sequence of addresses is used in an asynchronous first-in-first-out (FIFO) data structure, which may include, for example, a FIFO memory having a depth D and a code generator coupled to the FIFO memory. The first code sequence may be generated from a second code sequence by removing one or more pairs of mirrored codes of the second code sequence.

### RELATED APPLICATIONS

This application is a continuation in part of U.S. patent application Ser. No. 10/692,957, “SYSTEM AND METHOD FOR DESIGNING DATA STRUCTURES”, filed Oct. 24, 2003, by Pande, which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

First-in-first-out (FIFO) data structures have been employed in many applications including, for example, very large scale integration (VLSI). A FIFO may be a memory unit or an integrated circuit, which may include address counters, control logic and a memory unit. As its name indicates, a FIFO data structure is one where the first data into the data structure is the first data removed from the data structure, or the first data written to the data structure is the first data read from the data structure. Generally, FIFO data structures may be broadly classified as either synchronous or asynchronous.

A FIFO data structure in which data is written and from which data is read, has a read port and a write port. A synchronous FIFO data structure may be, for example, a data structure in which a single clock controls the write port and the read port of the FIFO data structure. A typical objective of the synchronous FIFO design is to provide a mechanism for buffering data and subsequently evacuating the buffered data in the order of arrival.

An asynchronous FIFO data structure may be, for example, a FIFO data structure in which a first clock is used to control the write port and a second clock is used to control the read port of the FIFO data structure. The first clock and the second clock may have completely arbitrary phase relationships. In addition to acting as a buffer, the asynchronous FIFO design has been used as a mechanism that reliably transfers data across asynchronous clock domains.

Conventional asynchronous FIFO data structures may be designed for depths of 2ⁿ in which n is an integer. However, being restricted to such depths may be the source of a number of inefficiencies. For example, in an application that may be optimized for a FIFO depth of 9, the use of a FIFO data structure with a depth of 2⁴ (i.e., 16) would not fully use all of the available buffer space and would needlessly consume valuable real estate on a printed circuit board or an integrated system (e.g., an integrated chip). The excessive FIFO data structure design may also disrupt stringent fan-out constraints on clock and data signals.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be seen in a method for generating a sequence of binary addresses of length 2D, where D may be the depth of a data structure, and D may be an arbitrary integer. The method for generating the sequence comprises generating a sequence of binary addresses with a length N, wherein N is greater or equal to the desired sequence length 2D, wherein N is a power of 2; selecting a combination of 2D addresses from the generated sequence; checking if the addresses in the selected combination satisfy the property of only one bit difference between consecutive addresses; and repeating the selecting of a combination and the checking until a combination of 2D addresses that satisfies the one bit difference property is found.

The method for generating a sequence of binary addresses may be implemented using a circuit comprising a processor; and a memory connected to the processor. The memory of the circuit being capable of storing a plurality of instructions, wherein execution of the instructions by the processor causes generating a sequence of binary addresses with a length N, wherein N is greater or equal to the desired sequence length 2D, wherein N is a power of 2; selecting a combination of 2D addresses from the generated sequence; checking if the addresses in the selected combination satisfy the property of only one bit difference between consecutive addresses; and repeating the selecting of a combination and the checking until a combination of 2D addresses that satisfies the one bit difference property is found.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates block diagram of an exemplary asynchronous FIFO data structure, in accordance with an embodiment of the present invention.

FIG. 2 illustrates exemplary Gray-coded addresses for a FIFO RAM with depth D equal to 8, in accordance with an embodiment of the present invention.

FIG. 3 illustrates a flow diagram of a process that generates with exhaustive search a Gray-coded sequence, in accordance with an embodiment of the present invention.

FIG. 4 illustrates an exemplary computer system, in accordance with an embodiment of the present invention.

### DETAILED DESCRIPTION OF THE INVENTION

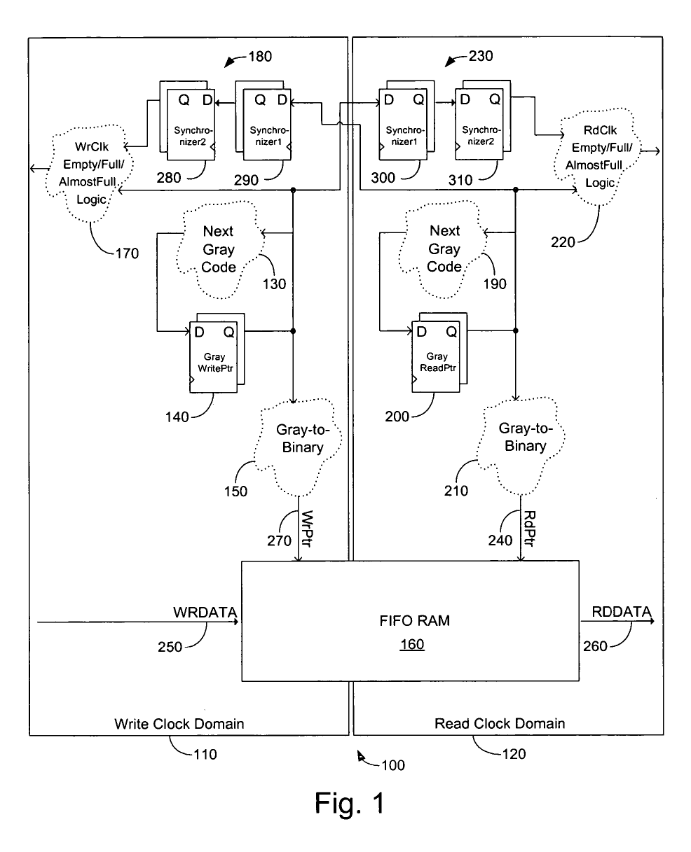

FIG. 1 illustrates a block diagram of an exemplary asynchronous FIFO data structure 100, in accordance with an embodiment of the present invention. The asynchronous FIFO data structure 100 may comprise a write clock domain 110 and a read clock domain 120. The write clock domain 110 may include a write clock. The read clock domain 120 may include a read clock. The write clock and the read clock may be asynchronous. In addition, one or both of the clocks may not be free running.

The write clock domain 110 may include a Gray-code generator 130, a Gray-code write pointer 140, a Gray-to-binary converter 150, write clock logic 170 related to generating an empty, full or almost full signal, and synchronizers 180. The read clock domain 120 may include a Gray-code generator 190, a Gray-code read pointer 200, a Gray-to-binary converter 210, read clock logic 220 related to generating an empty, full or almost full signal and synchronizers 230.

In one embodiment of the present invention, the asynchronous FIFO data structure 100 may include a FIFO RAM 160, which may be part of the write clock domain 110 and the read clock domain 120. The FIFO RAM 160 may have as inputs a binary write pointer (WrPtr) 270, a binary read pointer (RdPtr) 240, a write data port (WRDATA) 250, and a write clock. The FIFO RAM 160 may have as output a read data port (RDDATA) 260. The FIFO RAM 160 may have a FIFO depth of any arbitrary depth D in which D is an integer and need not be limited merely to depths of 2^{N} in which N is an integer. In one embodiment of the present invention, the length of the Gray-code sequence may be 2D, where D may be an arbitrary integer indicating the depth of the FIFO RAM 160.

In one embodiment of the present invention, according to the write clock in the write clock domain 110, a Gray-code write pointer 140 may point to the next Gray-code address to be written. The Gray-to-binary converter 150 may convert the Gray-code address to a binary address WrPtr 270, which may point to a corresponding address in the FIFO RAM 160. WRDATA 250 may then write data into the FIFO RAM 160 at the memory location associated with the binary address pointed to by WrPtr 270. After the data is written into the FIFO RAM 160 appropriate location, the Gray count may be incremented according to the Gray-code generator 130. The write clock logic 170 may generate an empty signal, a full signal, or an almost full signal depending upon the state of the FIFO pointer registers in the FIFO RAM 160.

In one embodiment of the present invention, according to the read clock in the read clock domain 120, a Gray-code read pointer 200 may point to the next Gray-code address to be read. The Gray-to-binary converter 210 may convert the Gray-code address to a binary address RdPtr 240, which may point to a corresponding address in the FIFO RAM 160. RDDATA 260 may then read data out of the FIFO RAM 160 at the memory location associated with the binary address pointed to by RdPtr 240. After the data is read out of the FIFO RAM 160 appropriate location, the Gray count may be incremented according to the Gray-code generator 190. The read clock logic 220 may generate an empty signal, a full signal, or an almost full signal depending upon the state of the FIFO pointer registers in the FIFO RAM 160.

In an asynchronous FIFO data structure, the write clock in the write clock domain 110 and the read clock in the read clock domain 120 may not be synchronous, in the sense that their rising and falling edges do not occur at the same time relative to each other. As a result, meta-stability issues may arise, which may impede reliable transfer of data from the one clock domain to another. Meta-stability may occur when data comes from one clock domain and the data gets captured in another clock domain, which may be asynchronous if there is not a fixed timing relationship between those two clocks. When the data is sent from one clock domain and received in the other, it may cause a set-up-and-hold violation of the flip-flop.

A set-up-or-hold violation occurs when data going into a register does not stabilize before a clock's set-up time, and the data fails to stay at the same value during the hold time, which is a time period following the set-up time during which the data is expected to remain at the same value after the set-up time.

In an embodiment of the present invention, meta-stability issue may arise and may cause erroneous reading of data from or writing of data to the FIFO RAM 160 resulting from the write clock and the read clock being asynchronous. Meta-stability may occur if data is read or data is written during the set-up time or the hold time, which causes a set-up-and-hold violation. For example, the system may try to read data according to the read clock, but if the clocks in the read domain and in the write domain are asynchronous, the data being read may change while it is being read, when data is written according to the write clock. This would pose problems in the system, because there needs to be a time during the clock period when the data should not change. Data is required to be stable during the set-up time and the hold time of the clock of the domain in which it is being exploited.

In an embodiment of the present invention, the synchronizers 180 may be used, for example, to synchronize the Gray-code read pointer into the write clock domain 110. As a result data may be read from the FIFO RAM 160 using the write clock after synchronizing it with the read clock. Hence, the gray read-pointer 200 is synchronized to the write clock domain by the synchronizers 180. The output of the synchronizers 180 is then compared with the gray write-pointer 140 by the write clock logic 170 to determine whether the FIFO is full. If the FIFO is full, further write commands are stopped. Similarly, the synchronizers 230 may be used to synchronize the Gray-code write pointer into the read clock domain 120. As a result data may be written to the FIFO RAM 160 using the read clock after synchronizing it with the write clock. Hence, the gray write-pointer 140 is synchronized to the read clock domain by the synchronizers 230. The output of the synchronizers 230 is then compared with the gray read-pointer 200 by the read clock logic 220 to determine whether the FIFO is empty. If the FIFO is empty, further read commands are stopped.

In one embodiment of the present invention, the synchronizers 180 are a set of back-to-back flip-flops 280, 290. The first flip-flop 290 may receive read data from the read clock domain 120. The read data, in one embodiment of the present invention, may be the value of the current RdPtr 240 in Gray code. The read data is in the read clock domain 120, and is synchronized with the read clock. The flip-flops 280, 290 are in the write clock domain 110, and are driven by the write clock. The flip-flops 280, 290 may have analog gain, thus any meta-stability issues arising may be resolved by applying the analog gain to a signal going through a flip-flop. Utilizing back-to-back flip-flops may provide extra assurance that if meta-stability issues are not resolved after going through the first flip-flop 290, the meta-stability issues will be resolved after putting the signal through a second flip-flop 280, also driven by the write clock. The output of the back-to-back flip-flops 280, 290, or the synchronizers 180 may be then equivalent to RdPtr 240 synchronized to the write clock in the write clock domain 110. This synchronization may make it possible to carry out operations and comparisons between RdPtr 240 and WrPtr 270 without being concerned with meta-stability issues, or that the read clock and the write clock may be asynchronous.

In one embodiment of the present invention, the synchronizers 230 are a set of back-to-back flip-flops 300, 310. The first flip-flop 300 may receive write data from the write clock domain 110. The write data, in one embodiment of the present invention, may be the value of the current WrPtr 270 in Gray code. The write data is in the write clock domain 110, and is synchronized with the write clock. The flip-flops 300, 310 are in the read clock domain 120, and are driven by the read clock. The flip-flops 300, 310 may have analog gain, thus any meta-stability issues arising may be resolved by applying the analog gain to a signal going through a flip-flop. Utilizing back-to-back flip-flops may provide extra assurance that if meta-stability issues are not resolved after going through the first flip-flop 300, the meta-stability issues will be resolved after putting the signal through a second flip-flop 310, also driven by the read clock. The output of the back-to-back flip-flops 300, 310, or the synchronizers 230 may be then equivalent to WrPtr 270 synchronized to the read clock in the read clock domain 120. This synchronization may make it possible to carry out operations and comparisons between WrPtr 270 and RdPtr 240 without being concerned with meta-stability issues, or that the write clock and the read clock may be asynchronous.

In one embodiment of the present invention, a WrPtr 270 may be synchronized to the read clock in the read clock domain 120 and compared with the RdPtr 240 to determine whether the FIFO RAM 160 is empty, full, or almost full. In one embodiment of the present invention, a comparator may be utilized to determine whether WrPtr 270 is equal to RdPtr 240, if they are equal that indicates that the FIFO RAM 160 is empty. When the FIFO RAM 160 is empty, there is nothing in it to read out, and nothing is read out of the FIFO RAM 160.

In one embodiment of the present invention, a RdPtr 240 may be synchronized to the write clock in the write clock domain 110 and compared with the WrPtr 270 to determine whether the FIFO RAM 160 is empty, full, or almost full. In one embodiment of the present invention, a subtractor and a comparator may be utilized to determine whether WrPtr 270 minus RdPtr 240 is equal to the depth D of the FIFO RAM 160, if so that indicates that the FIFO RAM 160 is full. When the FIFO RAM 160 is full, there are no more locations in it to write to, and nothing is written to the FIFO RAM 160. The subtractor may subtract the value of the RdPtr 240 from the WrPtr 270, the result may then be compared to the last address available for data in the FIFO RAM 160, if they are equal, then the FIFO RAM 160 is full.

The comparisons between the WrPtr 270 and the RdPtr 240 may not yield meaningful results, unless both signals are synchronized to the same clock, using a synchronization process such as, for example, the one described herein. In one embodiment of the present invention, the synchronization may be carried utilizing digital circuitry such as, for example, the aforementioned synchronizers 180, 230. The output of a digital circuit is one of two values, either 1 or 0. As a result, during synchronization an intermediate value may be posted as a 1 when in reality it is a 0. This may be a problem in a system utilizing a regular counter, where multiple bits may change from one address to another. For example, an address at 0111 would be followed by 1000, in which case, all 4 bits change. In an embodiment of the present invention, Gray coding may be utilized for addresses. The advantage of utilizing Gray coding lies in that only one bit changes from one address to another. For the previous example, 0111 in Gray coding may be followed by 0101, 1111, 0011, or 0110. The result is that the problems caused by an error during the synchronization process are greatly mitigated. In one embodiment of the present invention, if an error occurs during synchronization, circuitry may be provided to correct such errors, by exploiting the one-bit-transition property of Gray coding.

In one embodiment of the present invention, the depth D of the FIFO RAM 160 may be such that 2D=2^{N}, where N is an integer. In this embodiment, it is quite simple to come up with Gray-coded addressing, in which each location of the FIFO RAM 160 may be coded utilizing Gray coding for synchronization purposes, then converted to the binary FIFO RAM 160 locations by the Gray-to-Binary converters 150, 210.

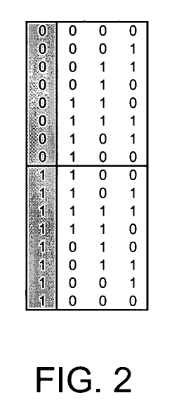

FIG. 2 illustrates exemplary Gray-coded addresses for a FIFO RAM 160 with depth D where 2D is equal to 16, in accordance with an embodiment of the present invention. In this example, the locations in the FIFO RAM 160 range in value from 0-15. The Gray-coded addresses illustrated in FIG. 2 represent those 16 locations, with the property that to transition from one address to another only one bit changes. These Gray-coded addresses also have a circular property in that the transition between the first and the last address is also exemplified by the change of 1 bit.

In one embodiment of the present invention, the depth D of the FIFO RAM 160 may not be a power of 2. In other words, 2D cannot be written as 2^{N}. Gray-coded addresses may be generated of length 2^{N}, where 2^{N-1}<2D<2^{N}. The Gray-coded addresses may have the mirroring property, as illustrated by the addresses shown in FIG. 2. The mirroring property may be exploited to choose a chunk of the addresses with a length equal to 2D, not a power of 2, while retaining the one-bit-transition property, and the circular property of the addresses.

In one embodiment of the present invention, 2D may not be equal to a power of 2. In this embodiment, what may be done is, using as an example a depth D equal to 5, starting with a list of 16 addresses sequentially ranging from 0-15. The first step may be simply taking the first 10 addresses, or the addresses from 0-9. It may be obvious that the numbers 0-9 will not have the desired property. The process then continues by choosing another chunk of 10 numbers and checking whether those have the desired property of one-bit-transition between consecutive addresses, in addition to the mirroring property. If not, continue this process of exhaustively searching all possible combinations and permutations of 10 addresses, until 10 addresses with the desired properties are found.

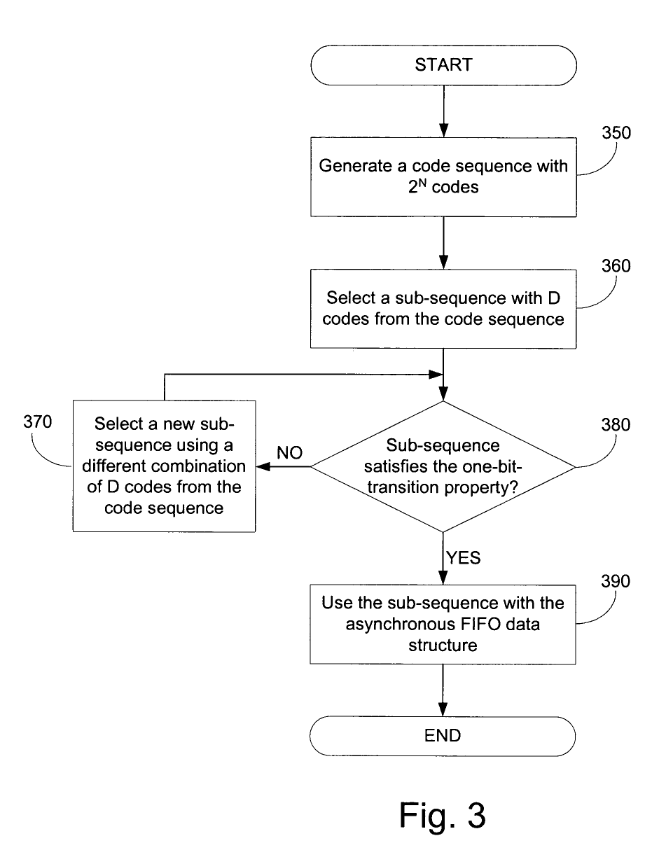

FIG. 3 illustrates a flow diagram of a process that generates with exhaustive search a Gray code sequence, in accordance with an embodiment of the present invention. At 350, a Gray code sequence is generated. The length of the sequence is 2^{N}, where 2^{N-1}<2D<2^{N}, and where D is the depth required by a FIFO data structure. In addition, D may be an odd or an even integer. At 360 a sequence of length 2D is selected from the sequence of length 2^{N} The selected 2D-length sequence is then examined at 380 to determine whether the sub-sequence has the property of one-bit-transition between consecutive addresses and the mirroring property. If the sub-sequence does not have those properties, then a new combination of 2D elements is selected from Gray code sequence, at 370. Until the sub-sequence has the desired properties, 380 and 370 are repeated. Once a sub-sequence is found to satisfy those properties, the sub-sequence is used with the asynchronous FIFO data structure, at 390. The selected sub-sequence may be utilized by the Gray-code generators 130, 190 to generate the Gray-code WrPtr and the Gray-code RdPtr.

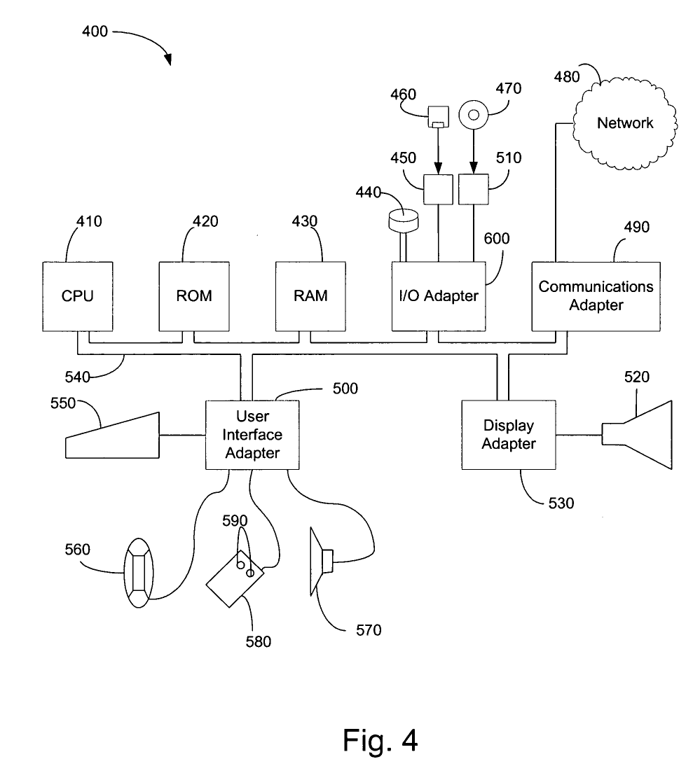

FIG. 4 illustrates an exemplary computer system 400, in accordance with an embodiment of the present invention. A central processing unit (CPU) 410 may be interconnected via a system bus 540 to a random access memory (RAM) 430, a read only memory (ROM) 420, an input/output (I/O) adapter 600, a user interface adapter 500, a communications adapter 490, and a display adapter 530. The I/O adapter 600 may connect to the bus 540 peripheral devices such as hard disc drives 440, floppy disc drives 450 for reading removable floppy discs 460, and optical disc drives 510 for reading removable optical discs 470 (such as a compact disc or a digital versatile disc). The user interface adapter 500 may connect to the bus 540 devices such as a keyboard 550, a mouse 580 having a plurality of buttons 590, a speaker 570, a microphone 560, and/or other user interface devices such as a touch screen device (not shown). The communications adapter 490 may connect the computer system to a data processing network 480. The display adapter 530 may connect a monitor 520 to the bus 540.

An embodiment of the present invention may be implemented as sets of instructions resident in the RAM 430 of one or more computer systems 400 configured generally as described in FIG. 4. Until required by the computer system 400, the sets of instructions may be stored in another computer readable memory, for example in a hard disc drive 440, or in removable memory such as an optical disc 470 for eventual use in an optical disc drive 510, or in a floppy disc 460 for eventual use in a floppy disc drive 450. The physical storage of the sets of instructions may physically change the medium upon which it is stored electrically, magnetically, or chemically so that the medium carries computer readable information.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A circuit comprising:
a processor; and
a memory connected to the processor, said memory storing a plurality of instructions, wherein execution of the instructions by the processor causes:
(a) generating a sequence of binary addresses with a length N, wherein N is greater or equal to a desired sequence length 2D, wherein N is a power of 2;
(b) selecting a combination of 2D addresses from the generated sequence;
(c) checking if the addresses in the selected combination satisfy the property of only one bit difference between consecutive addresses; and
(d) repeating (b) and (c) until a combination of 2D addresses that satisfies the one bit difference property is found.

2. The circuit according to claim 1 wherein D is an arbitrary number.

3. The circuit according to claim 1 wherein D is the depth of a data structure.

4. A method for generating a sequence of binary addresses of length 2D, the method comprising:
(a) generating a sequence of binary addresses with a length N, wherein N is greater or equal to the desired sequence length 2D, wherein N is a power of 2;
(b) selecting a combination of 2D addresses from the generated sequence;
(c) checking if the addresses in the selected combination satisfy the property of only one bit difference between consecutive addresses; and
(d) repeating (b) and (c) until a combination of 2D addresses that satisfies the one bit difference property is found.

5. The method according to claim 4 wherein D is an arbitrary number.

6. The method according to claim 4 wherein D is the depth of a data structure.
